(19) United States
(12) Patent Application Publication
(10) Pub. No.: US 2002/0044677 A1
(43) Pub. Date: Apr. 18, 2002

(54) Denomination identification

(75) Inventor: Jeremy Fox, Portsmouth (GB)

Correspondence Address: Oliff & Berridge PLC, P.O. Box 19928, Alexandria, VA, 22320, US

(73) Assignee: DE LA RUE INTERNATIONAL LIMITED

(21) Appl. No.: 09/739,769

(22) Filed: Dec. 20, 2000

(30) Foreign Application Priority Data
Oct. 18, 2000 (GB) 0025564.6

(51) Int. Cl. G06K 9/00

(52) U.S. Cl. 382/135

(57) ABSTRACT

A method and apparatus for identifying the denomination of a sample currency bill. The method comprises:

a. Scanning the sample currency bill to generate a number of sample patterns, each sample pattern representing variations in properties of a respective bill portion of the scanned sample currency bill;

b. Correlating each sample pattern with a number of master patterns, each master pattern representing variations in the properties of a respective bill portion of a respective denomination currency bill, each bill portion containing at least a predetermined number of bill features, the bill features allowing different denominations of currency bill to be distinguished; and,

c. Determining the denomination of the sample currency bill in accordance with the result of the correlation.

### FIELD OF THE INVENTION

The present invention relates to methods and apparatus for identifying the denomination of a sample currency bill.

### DESCRIPTION OF THE PRIOR ART

Many products exist for counting and sorting documents such as the De La Rue 2800 machine. In these machines, the documents are loaded into an input station, transported past one or more detectors which sense respective characteristics of the documents and then, depending upon the outcome of the characteristics which are detected, the documents are fed to an appropriate one of the output stations.

In some circumstances, the transport may be stopped on the detection of a particular type of document and where this facility is provided, it is possible to utilize a single output station.

Thus, for example, in the case of banknotes, these can be sorted on the basis of denomination. In order to determine the denomination of banknote fed through the machine, a number of different discrimination methods can be used.

In general all these techniques involve scanning the banknote to determine a banknote pattern which is representative of various banknote characteristics, such as reflectivity or transmissivity. This banknote pattern is then compared to a number of “master” patterns each of which represent a different denomination. The results of the comparison are then used to decide the denomination of the banknote.

A typical example is described in U.S. Pat. No. 6078683. In this case, the banknote is scanned using a transmission scanner to determine the transmissivity of the banknote over its entire area. This is used to generate a pixelated image, with the value of each pixel representing the transmissivity of the banknote at a corresponding location. This image is then deskewed and typically sub-filtered to obtain the banknote pattern.

The banknote pattern is then correlated with a number of master patterns by calculating the scalar product of the banknote pattern with each mater pattern. In this case the banknote pattern and the master pattern are represented as vectors with each dimension of the vector representing the transmission characteristics of the banknote at a different pixel location. Once this has been completed, the denomination of the banknote is determined to be the same as the denomination of the master pattern with which the banknote pattern has the highest correlation.

A number of additional variations to this basic concept have also been applied in the De La Rue 2700 machines.

The first variation involves a process called feature selection. Feature selection is based upon the realisation that not all areas of the banknote are helpful in distinguishing between denominations. Thus, for example, the pattern used may be substantially the same for different denomination banknotes with only, for example, numerical differences in the banknote denomination value.

As a result of this, if two different denomination banknotes are scanned, the pixel values for at least some of the pixel locations in the banknote patterns will be substantially identical. Comparing these pixels which are identical, or at least substantially similar, will not therefore help in the distinction process.

Accordingly, feature selection is applied by examining the master patterns and eliminating any pixels in the master patterns which are substantially identical between the master patterns of different denominations. As a result, the final master pattens only contain pixels which are different between the different denominations.

When the banknote pattern is then generated, only the pixels which correspond to the chosen pixel locations in the master pattern are used for performing the correlation step. This can result in up to a ten fold decrease in the number of pixels present in the master patterns, thereby helping to reduce the amount of processing which is involved.

A further alternative is to divide the banknote into five adjacent columns with master patterns being generated for each column. In this case, when a sample banknote is scanned, a separate banknote pattern is generated for each column. These are then compared to corresponding master patterns for each column.

The denomination of the banknote is then determined if the majority of the five columns are identified as being columns from the same denomination banknote. This helps overcome the problems encountered with image degradation in a single column, such as occurs for example when the corner of a banknote is folded over.

However, this technique suffers from the major drawback that columns on different denomination banknotes may be substantially identical depending on the banknote design.

### SUMMARY OF THE INVENTION

In accordance with a first aspect of the present invention, we provide a method of identifying the denomination of a sample currency bill, the method comprising:

a. Scanning the sample currency bill to generate a number of sample patterns, each sample pattern representing variations in properties of a respective bill portion of the scanned sample currency bill;

b. Correlating each sample pattern with a number of master patterns, each master pattern representing variations in the properties of a respective bill portion of a respective denomination currency bill, each bill portion containing at least a predetermined number of bill features, the bill features allowing different denominations of currency bill to be distinguished; and,

C. Determining the denomination of the sample currency bill in accordance with the result of the correlation.

In accordance with a second aspect of the present invention, we provide a method of identifying the denomination of a sample currency bill, the method comprising:

a. Selecting a number of bill features which allow different denominations of currency bill to be distinguished;

b. Defining a number of bill portions, each bill portion containing at least a predetermined number of bill features;

c. Determining a master pattern for each bill portion of each denomination, each master pattern being determined by scanning the respective bill portion of a currency bill having the respective denomination;

d. Correlating the sample currency bill with at least a number of the master patterns by:

i. Scanning each bill portion of the sample currency bill to generate sample patterns for each bill portion of the sample currency bill;

ii. Correlating each sample pattern with the number of master patterns of the respective bill portions; and,

iii. Determining the denomination of the sample currency bill in accordance with the result of the correlation.

In accordance with a third aspect of the present invention, we provide apparatus for identifying the denomination of a sample currency bill, the apparatus comprising:

a. A scanning system for scanning the sample currency bill to generate a number of sample patterns, each sample pattern representing variations in properties of a respective bill portion of the scanned sample currency bill;

b. A store for storing master patterns, each master pattern representing variations in the properties of a respective bill portion of a respective denomination currency bill, each bill portion containing at least a predetermined number of bill features, the bill features allowing different denominations of currency bill to be distinguished; and,

c. A processor coupled to the scanning system and the store, wherein the processor is adapted to determine the denomination of a sample by

i. Correlating each sample pattern with at least a number of the master patterns of the respective bill portions for the different denominations of currency bill; and,

ii. Determining the denomination of the sample currency bill in accordance with the result of the correlation.

Accordingly, we provide apparatus and methods for identifying the denomination of sample currency bills. In the present invention, this is achieved by considering the currency bills as having a number of portions. Each portion is defined to include at least a predetermined number of bill features, the bill features being features which allow different denominations of currency to be distinguished. Accordingly, the bill portions are selected based on the bill features and not the dimensions of the banknote. As a result, each bill portion can be a different shape and can indeed be formed from a number of locations distributed throughout the area of the entire banknote. Master patterns are similarly generated for each bill portion of each denomination. Accordingly, once sample patterns representing variations in properties of a respective bill portion have been determined, these are correlated with the master patterns to determine the denomination of the sample currency bill.

Optionally, denomination domains are defined, each domain containing a number of different denominations. In this case, the method preferably further comprises selecting the number of master patterns by correlating domain sample patterns with domain master patterns, each domain master pattern representing the variations in the properties of a respective bill portion of the respective number of different denominations, each domain sample pattern representing variations in properties of a respective domain bill portion of the scanned sample currency bill, each domain bill portion containing at least a predetermined number of bill features allowing the domain of the sample currency bill to be distinguished.

This allows the correlation of the sample patterns to be carried in stages. Thus the first stage can be correlation with the domain master patterns, thereby allowing the subsequent correlation to be carried out on a limited number of master patterns.

In the case in which domains are used, it is not necessary for the domain master patterns to be defined for the same bill portions. Thus, instead domain bill portions may be used when deciding which domain the sample bill falls within. In this case, with the different domain bill portions being used, domain sample patterns based on the domain bill portions must also be utilised.

The correlation at the domain stage is used to determine with which master patterns the sample pattern should be correlated. As this second correlation stage is completely independent of the first, a second set of bill portions can therefore be used when deciding which denomination the sample currency bill has. This is not however essential to the present invention.

When domains are used, the domain master patterns are preferably stored in the store.

Typically the method of scanning the sample currency bill to generate sample patterns comprises:

a. Progressively exposing adjacent segments of the sample currency bill to radiation;

b. Detecting the radiation transmitted by or reflected from each segment of the sample currency bill, to thereby determine a bill pattern for the entire sample currency bill; and,

c. Dividing the bill pattern into a number of sample patterns in accordance with the bill portions.

Accordingly, the system operates by progressively scanning the entire banknote to obtain reflectance or transmission readings for the entire sample bill. Once this has been completed, the obtained bill pattern is divided into a number of sample patterns on the basis of the predetermined bill portions. Thus, the bill portions can for example be determined as a mask which can be applied to the bill pattern to determine the sample patterns. As an alternative however, the banknote can be repeatedly scanned using a similar system to that described above with each scan being directed towards obtaining reflectance or transmission readings from a particular bill portion of the banknote.

The properties of the bill in this case are therefore transmission or reflectance characteristics of the bill when exposed to the radiation. Again, other characteristics may be used as appropriate, such as magnetic properties of the ink in the case of US banknotes, the fluorescence of the ink, the presence of a watermark, or the like.

Typically the method of correlating the sample patterns with the master patterns comprises:

a. Representing the master patterns as vectors, each dimension of each vector representing the variations in the bill properties at a given point of the bill portion;

b. Representing the sample patterns as vectors, each dimension of each vector representing the variations in the properties of the sample currency bill at the given point of the bill portion;

c. Determining the scalar product of each sample pattern with the master patterns of the respective bill portions for each denomination; and,

d. Determining the denomination of the sample pattern to be the denomination of the master pattern for which the highest scalar product is determined.

Accordingly, the present invention usually uses a fairly standard correlation technique. However, alternative correlation techniques, or even a direct comparison may also be used.

In the above mentioned correlation technique the master patterns are preferably normalized vectors. This has the advantage that the magnitude of the scalar product is representative of the correlation between the master pattern and the sample pattern, as will be appreciated by a person skilled in the art.

The denomination of the sample bill is usually determined if the majority of the sample patterns correlate with the master patterns of a given denomination. Thus, if more than half of the bill portions are determined to be from a five dollar bill, then the sample bill will be determined to be a five dollar bill. However, this need not be a simple majority but may be based on a threshold level depending on the number of bill portions the bills have been divided into. Thus, for example if there are ten bill portions present on any one bill, the denomination of the sample bill may only be determined if seven of the ten bill portions are determined to of the same denomination.

The bill features are typically bill locations which have respective different properties for respective different denominations. Thus, an area, typically a pixel or sub-pixel, which has identical properties on all denominations of banknote, such as a border or the like will not comprise a bill feature. This ensures that the comparison is carried out using the least amount of data possible which still allows an accurate result to be obtained.

Typically each bill portion is defined in terms of a number of bill features. This allows the bill features that form any bill portion to be distributed throughout the entire area of the bill. Thus, for example one bill portion may comprise bill features located at each corner of the currency bill, whilst a different bill portion may include only bill features located near the center of the banknote. As a result the bill portions may or may not correspond to geometric shapes which could be overlaid onto the image of a banknote.

The scanning system used by the present invention usually comprises:

a. A radiation source for selectively exposing the sample currency bill to radiation;

b. A bill transport system for transporting the bill past the radiation source, the bill transport and the radiation source cooperating so as to progressively expose adjacent segments of the sample currency bill to radiation; and,

c. A detector for detecting the radiation transmitted by or reflected from each segment of the sample currency bill to thereby determine a bill pattern for the entire sample currency bill.

As mentioned above, radiation scanning may not be used, for example if magnetic inks or fluorescence detection is used.

The correlation process is usually carried out by the processor which is adapted to obtain the master patterns from the store. In addition to storing master patterns in the store, the present invention typically stores details of the locations of the bill features which form the bill portions in the store. This may be done by specifying specific locations on a bill, or may be achieved in terms of storing a geometric shape representation which when overlaid on a bill image defines the bill portion.

In accordance with a fourth aspect of the present invention, we also provide a method of generating master patterns for identifying the denomination of a sample currency bill, the method comprising:

a. Scanning one or more currency bills of each denomination so as to determine component patterns representing variations in properties of the scanned currency bills;

b. Comparing the component patterns of different denomination scanned currency bills to determine a number of bill features which allow the different denominations to be distinguished;

c. Defining a number of bill portions, each bill portion containing at least a predetermined number of bill features; and,

d. Generating a master pattern for each bill portion of each denomination, each master pattern being determined by scanning the respective bill portion of a currency bill having the respective denomination.

Accordingly, the present invention also provides a method of generating the master patterns. This is achieved by scanning one or more currency bills of each denomination and then comparing the bill patterns generated by this process to determine the bill features which allow the denominations to be distinguished. Once this has been completed, the master patterns are generated for each bill portion of each denomination. However, the bill features may alternatively be identified based on the knowledge of the person determining the master patterns, or the like.

As will be appreciated by a person skilled in the art, master patterns generated in accordance with the fourth aspect of the present invention may typically be used in any of the first three aspects of the present invention.

### BRIEF DESCRIPTION OF THE DRAWINGS

An example of the operation of the present invention will now be described with reference to the accompanying drawings, in which:

FIG. 1 is a schematic diagram of a first example of a counter/sorter utilizing the present invention;

FIG. 2 is a block diagram of the non-mechanical components in the counter/sorter of FIG. 1;

FIG. 3 is a schematic side view of the linear detector array of FIG. 1;

FIG. 4 is a schematic plan view of the linear detector array of FIG. 1;

FIG. 5 is a flow diagram describing the operation of the counter of FIG. 1;

FIG. 6A an example of the location of the bill portions on an example one flavia banknote;

FIG. 6B an example of the location of the bill portions on an example five flavia banknote;

FIG. 7 is an example of the distribution of a number of sample banknotes of two different denominations plotted in a 2-D space;

FIG. 8 is an example of the distribution of denomination master patterns and domains plotted in a 2-D space; and,

FIG. 9 is a flow diagram of the hierarchical correlation technique.

### DETAILED DESCRIPTION OF EMBODIMENT

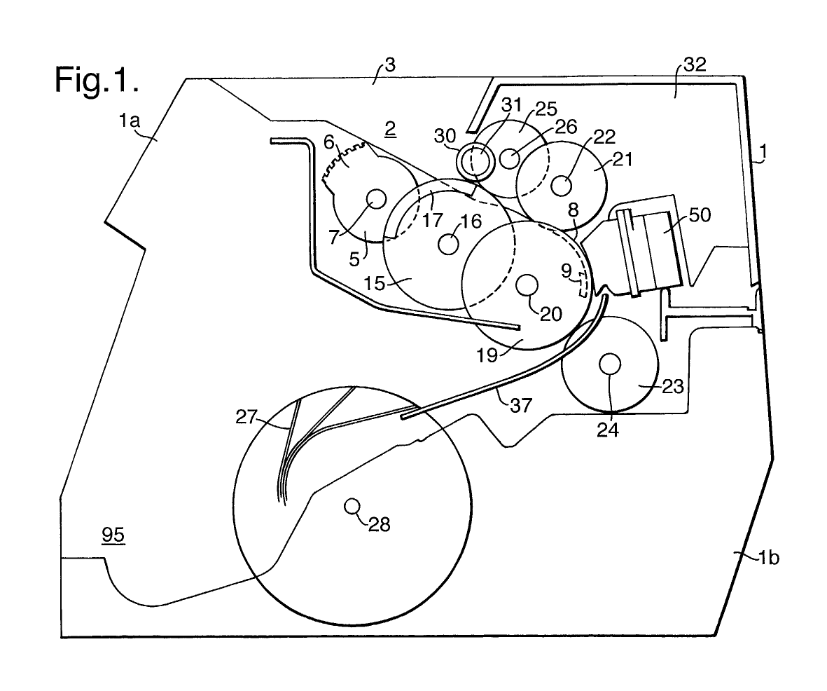

The present invention is typically implemented in a counter as shown in FIG. 1. As shown, the counter includes an input hopper 2 mounted beneath an inlet opening 3 in an enclosure 1 which comprises upper and lower parts 1a, 1b normally screwed together. Contained within the enclosure 1 is an internal chassis assembly (not shown for clarity) which itself has side members between which the sheet feeding and transport components to be described herein, are mounted. Two conventional feed wheels 5 are non-rotatably mounted on a shaft 7, which is rotatably mounted to the chassis assembly, and have radially outwardly projecting bosses 6 which, as the feed wheels rotate, periodically protrude through slots in the base of the hopper 2.

A pair of stripper wheels 15 are non-rotatably mounted on a drive shaft 16 which is rotatably mounted in the chassis assembly. Each stripper wheel 15 has an insert 17 of rubber in its peripheral surface. Shaft 16 is driven clockwise by a motor 200 (FIG. 2) to feed banknotes individually from the bottom of a stack of banknotes placed in the hopper 2.

Transversely in alignment with, and driven from the circumferential peripheral surface of the stripper wheels 15, are pressure rollers 30 which are rotatably mounted on shafts 31 spring based towards the stripper wheels 15. Downstream of the wheels 15 is a pair of transport rollers 19 non-rotatably mounted on a shaft 20 rotatably mounted in the chassis assembly. Shaft 20 is driven clockwise from a second motor 210 (FIG. 2) to transport the banknote in the transport arrangement, in conjunction with pairs of pinch rollers 21 and double detector rollers 23, into stacking wheels 27 and hence output hopper 95. Pinch rollers 21, rotatably mounted on shafts 22 spring based towards the transport rollers 19, transversely align with rollers 19 and are driven by the peripheral surface of the rollers 19. The double detector rollers 23, rotatably mounted on shafts 24 are in alignment with the transport rollers 19, and are essentially caused to rotate by the banknote passing between the adjacent peripheral surfaces of the rollers 19 and 23.

Situated between the pressure rollers 30 and pinch rollers 21 are separator roller pair 25, non-rotatably mounted on shaft 26 adjustably fixed to a top molding assembly 32, having a circumferential peripheral surface which is nominally in alignment with the peripheral circumferential surface of, but transversely separated from, the stripper wheels 15.

Also forming part of the top molding assembly 32, is a curved guide surface 8 extending partly around the circumference of the rollers 15, 19 which, when the top molding is lifted allows the operator access to the banknote feed and transport path so that a banknote jam can be cleared. A surface 37 provides banknote guiding from the end of the curved guide surface 8 to the conventional stacking wheels 27.

The drive motor 200 continuously drives the drive shaft 16, and, via a belt and pulley arrangement from shaft 16, the auxiliary drive shaft 7 rotating the feed wheel 5. Drive shaft 20, rotating the transport rollers 19, is driven by the other drive motor 210. A further pulley and belt arrangement (not shown) between shaft 20 and shaft 28, on which the stacking wheels 27 are non-rotatably mounted, provides the drive to the stacking wheels 27.

A guide plate 9 extends as a continuation of the base of the hopper 2 towards the nips formed between the transport rollers 19 and the double detector rollers 23.

A linear detector array 50 is mounted adjacent to the transport path. This extends across the full length of the banknotes (transverse to the feed direction), so as to detect light reflected off the facing surface of banknotes as they pass beneath the detector. (Other known detectors could be used which, for example, only scan a portion or portions of the banknotes. Also, one or more detectors may be provided for determining transmittance, thickness, size etc. of the banknotes.) The array 50 is coupled to a processor 220 via an analogue to digital convertor (ADC) 250 which samples the array 50 to obtain data relating to the reflectance properties of the banknote.

Typically, signals from the double detect rollers 23 will be transferred to the microprocessor 220.

Accordingly, in use, banknotes entered into the input hopper 2 are transported along the transport path. The banknotes pass the detector array 50, which transfers reflectance signals to the processor 20 which operates to determine the denomination of the banknotes in question. The banknotes then pass through the double detect rollers 23 and enter the stacking wheels 27 and hence the output hopper 95.

The transfer of the banknotes to the output hopper 95 can be controlled in accordance with the detected denomination of the note. Alternatively the denomination indication can be used to calculate the value of the banknotes which are transferred to the output hopper 95, as will be appreciated by a person skilled in the art.

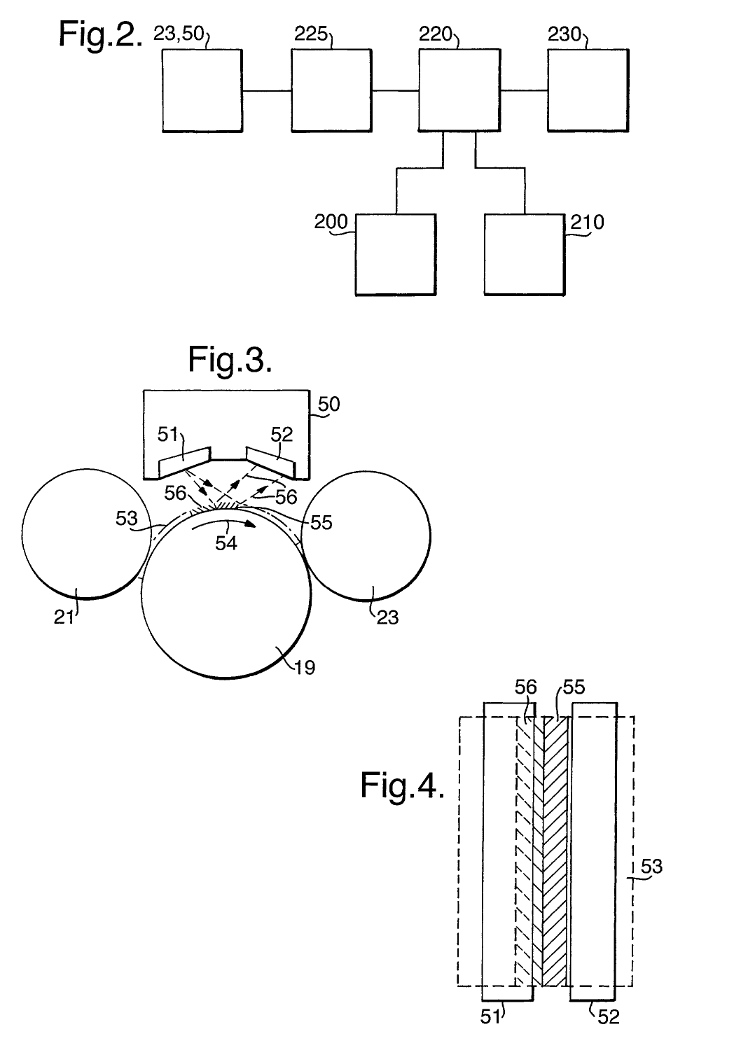

The detector array 50 is shown in more detail in FIGS. 3 and 4. As shown, the detector array 50 includes a linear LED array 51 positioned adjacent a linear photodiode array 52.

In use, a banknote (represented by the dotted line 53) is transported passed the detector array 50 in the direction shown by the arrows 54. The LED array generates a focused beam of radiation (typically in the visible region of the electromagnetic spectrum) which illuminates a strip 55 of the banknote 53. Light reflected from this strip of the banknote is detected by the photodiode array 52, as shown by the dotted lines 56.

The photodiode array 52 detects radiation reflected from the surface of the banknote 53. The photodiode array 52 includes a number of photodiodes (typically 54) each of which generates an analogue signal representative of the intensity of the reflected radiation incident thereon. The ADC 225 samples each of the photodiodes in turn so that the illuminated strip 55 is effectively divided into 54 pixels, with the reflected radiation being detected from each pixel in turn.

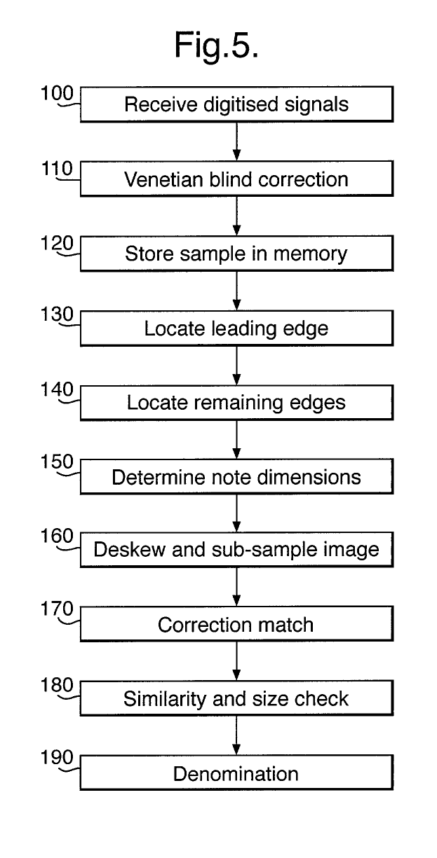

The sampled signals are converted into digital signals representative of the intensity of light detected by the respective photodiode before being transferred to the microprocessor 20 for subsequent processing as will be described below with respect to FIG. 5.

Additionally, the banknote is constantly moving in the direction of the arrow 54. Accordingly, once each of the photodiodes in the array 52 have been sampled, the ADC restarts the sample procedure. By this time, the bank note has moved relative to the detector array 50 so that an adjacent strip 56 of the banknote 53 is sampled, as shown. In this manner, an image of the banknote 53 can be produced.

Operation of the microprocessor 220 will now be described with reference to FIG. 5.

Firstly, as shown in step 100, the microprocessor operates to receive the digitised signals representing the image intensity of the sample pixels from the ADC. At step 110 a Venetian blind correction is performed before the correct samples are stored in the memory 230 at step 120.

Following this the processor 220 operates to process the data to determine the leading edge of the banknote at step 130 and then the remaining trailing, left and right edges of the banknote at step 140. Once the edges of the banknote have been determined, the banknote dimensions are determined at step 150 before the image data is deskewed and sub-sampled at step 160.

Following step 160, the processor 220 performs a correlation template match, matching the acquired sample patterns with master patterns stored in the memory 230. A best template score is then used to determine the denomination of the sampled banknote. A similarity and size check comparison is then performed at step 180 before the banknote denomination is confirmed at step 190.

Each of these stages will now be described in more detail below.

### Venetian Blind Correction

As described above, the photodiodes in the photodiode array 52 are sampled sequentially. The banknote 53 is however moving constantly. Accordingly, when the latter photodiodes are sampled, the banknote will have moved further along the note transport path than when the earlier photodiodes are sampled. As a result, the pixels on the strips 55,56 are effectively staggered along the length of the note as shown. Accordingly, the ensuing image distortion appears as a jagged Venetian blind effect on the banknote edges (which must also be present in the scanned pattern details).

This effect is exacerbated with increasing banknote speed. When running at the fastest setting, the pixels scanned later are virtually on the next line. To combat this distortion a “Venetian blind” correction interpolates the pixel values between the current reading and the value obtained on the previous line as a function of pixel position and banknote speed.

The number of idle ADC acquisition cycles between ending one line and starting the next are counted in the ADC acquisition interrupt routine. This count depends on the instantaneous banknote speed at the time each line was acquired. It is stored in an unused pixel location at the end of the line and represents the time between that line and the previous one. When the trigger module gets round to processing the line it first calculates the proportion of a full line delay incurred in the acquisition of one single pixel. This is passed back to a function in the ADC module that uses the pixel scan order table to build up a profile (array) of pixel interpolation factors identifying what percentage of the reading from the previous line to use. This in turn is passed to a routine that applies the correction and keeps a copy of the newly acquired line to be used as the previous line for next time.

Once this process has been completed a recognisable representation of the banknote image is stored in the memory 230 at step 120.

### Leading Edge Detection

Once the data has been stored in the memory 230 at step 120, the processor 220 operates to determine the position of the leading edge. This process is initiated as soon as a leading edge trigger has been detected allowing the system to obtain basic information about the leading edge of the banknote, such as the position gradient whilst the remaining data is detected. The arrival of a note is recognised by the difference between pixel values representing background, and values greater than a threshold distance away from background.

The detection of the leading edge uses a Radon transform to determine the most likely slope candidate. For a small group of pixels (typically, 7×7) centered around the trigger, the system calculates the total number of threshold pixels along paths of known slope and position. These parameters are adjusted and the process repeated until a 2D “map” is constructed. The maximum value in this array corresponds to the leading edge thus by looking at the axes for this value, the slope and position can be found.

The position and gradient are stored for later use.

### Remaining Edge Detection

Once the leading edge portion and slope has been determined by a radon transform, a point on each end of the leading edge is found by a thresholding algorithm. The nominal corners of the note are calculated, by a standard geometrical technique, from points on the leading edge and each end and the slope of the leading edge. There is, therefore, no need to wait for the trailing edge prior to de-skewing the image, and processing time is thereby considerably reduced.

Once all four edges have been located, the center of the banknote can be calculated. This allows the banknote dimensions to be calculated at step 150.

### Deskew and Sub-Sample

Next at step 160 a deskewed sub-sampled section of the banknote is generated. A 28×24 buffer is used with each pixel corresponding to 7×4 mm. For each pixel in this new buffer, an inverse deskew operation is performed to determine which of the original 52×60 pixels (3.5×2 mm) is to be used. This operation uses the slope of the leading edge calculated above and is based around the center of the banknote.

The advantage of using this inverse transform is that the convolution kernel is applied only to relevant pixels rather than the whole image. This has obvious benefits in terms of processing and storage requirements. Even though a restricted data set is being used, this is still a relatively computationally expensive process therefore the deskew routine is implemented in assembler. Before this routine is called, a structure containing skew and center information is completed and forms a wrapper around the assembler routine.

Accordingly, the de-skewing and sub-sampling are carried out together, so that there is, for instance, no de-skewed image at the higher resolution. The current scheme, two de-skewed/sub-sampled images are produced, that is one for each leading corner of the note. These images are 16 by 16 pixels, that is 64 mm by 112 mm.

Part of the edge finding routine outlined above involves subtracting calibration values from the higher resolution image. In this example, these values are only added back as far as is necessary to make the sub-sampled images.

Once the banknote has been subsampled and deskewed, the recognition process is performed in step 170. This process consists of several stages and so is described in more detail below.

### Verify Note Geometry

The next step 180 is to verify the geometry of the chosen banknote type. If the difference between the sizes of the banknote in the chosen class (stored in the template header) and the input banknote is sufficiently large then a size cull is flagged. This can take the form of a combination of the following:

DD_NOTE_HEIGHT_TOO_SMALL

DD_NOTE_HEIGHT_TOO_LARGE

DD_NOTE_WIDTH_TOO_SMALL

DD_NOTE_WIDTH_TOO_LARGE

An additional check is then made to determine whether the chosen vote was folded. The algorithm used for this relies on the fact that during training, each banknote class has a range of input images that have been shifted by specific amounts. As these are labelled in the template structure, it is a simple matter to determine whether the pattern was shifted in relation to the banknote edges. This would be caused by printer cut mis-registration or an end fold. This test determines whether the pattern shift corresponds to the difference in input banknote dimensions and actual banknote template. If this shift is equal to the geometric difference (within a tolerance) then an end fold has been observed. In these circumstances, the banknote is flagged for rejection rather than culling without prejudicing any classification or authentication results. The reject codes are:

DD_NOTE_HEIGHT_FOLD

DD_NOTE_WIDTH_FOLD

The final check is to determine whether the input banknote actually looks like the banknote to whose class it has been assigned. In this stage, a horizontal Sobel filter is applied to the input and is correlated with a Sobel filtered template. This filter is implemented in assembler for speed and to limit the amount of processing required, the vertical function is not applied. The idea behind this check is that the previous templates define constrained maximum separability between two classes and contain only those features that define differences between the two classes. It is possible to construct a false banknote which has these features but in fact looks nothing like the original banknote. Indeed, for a pixel size of 3.5×2 mm, a sheet of newsprint may contain enough features to be classified as a valid banknote.

This extra test uses all the pixels in the Sobel filtered input and obtains a correlation score from an aligned reference image. If this score is too low, the following cull flag is raised:

DD_PLAIN_PAPER_CULL

Once a decision has been reached and the apparatus confidence checks have been made, the processor 220 outputs a decision.

### Denomination Determination

Operation of the processor 220 to determine the denomination of the sampled bill will now be described.

Firstly, the processor 220 operates to determine the denomination of the banknote by comparing the sampled image to a number of master patterns which are derived from genuine banknotes of different denominations.

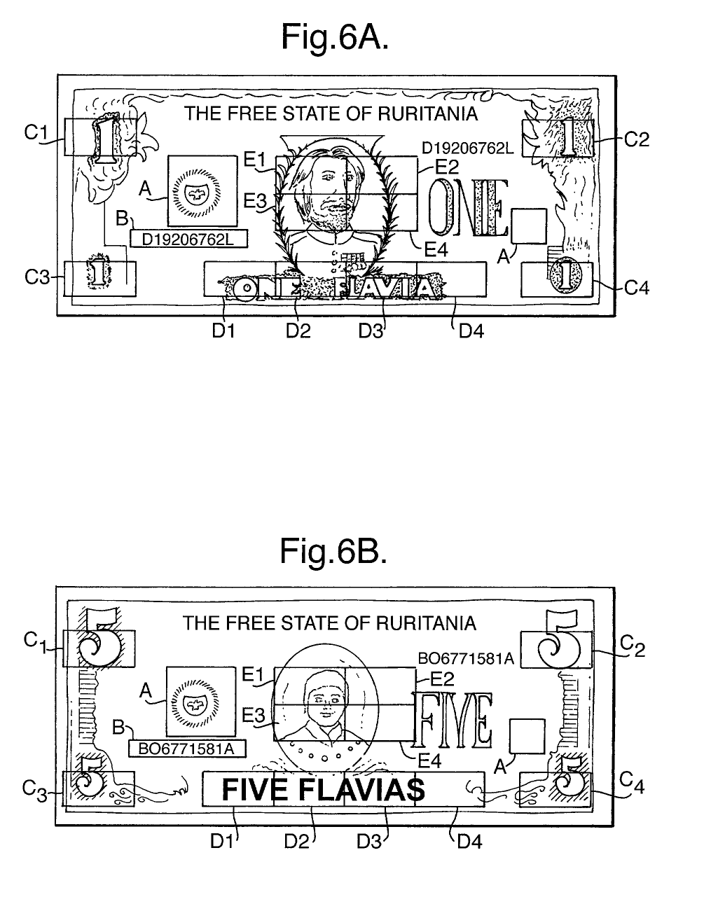

Rather than attempt to compare the entire image to master patterns representing the entire image of genuine banknotes, the present invention utilizes splodes. These are effectively predetermined portions of the banknotes which contain features which can readily be used to determine the banknote denomination as will be explained with respect to FIGS. 6A and 6B which show a five flavia and a one flavia banknote respectively from a fictional “Free State of Ruritania”.

As shown, the one and five flavia banknotes include a number of areas which are substantially identical in appearance. A number of these areas are shown at A. Accordingly, image information from these areas does not aid in allowing the one and five flavia banknotes to be distinguished. Thus if only these areas were scanned it would be impossible to distinguish the one and five flavia banknotes.

A number of further areas (areas B) vary between banknotes of the same denomination and again do not contribute towards the determination of the banknote denomination.

However, a number of portions of the banknote are distinctly different on each banknote. Thus, for example the portions of the one and five flavia banknotes marked C,D,E contain features which are distinct for the different denomination notes. These portions of the banknote (referred to as splodes) can therefore be used in the determination of the banknote denomination.

The individual points which allow a distinction to be achieved are known as banknote features. In this example, each splode is formed from four different features. The splode may contain features which are separated on the banknote. Thus for example, the splode C contains features C1,C2,C3,C4, which are located in the corners of the note. In contrast to this, the splodes D,E each contain four adjacent features D1,D2,D3,D4 and E1,E2,E3,E4 respectively.

Typically each feature corresponds to a single sub-pixel in the sub-sampled image, so that in this example, each splode would contain 4 pixel values. However, each feature may be formed from any number of pixels, as long as the number of pixels remains constant for any given feature. From this it will be realised that each feature always refers to the same part of the banknote image and therefore always contains the same number of pixels. Different features may however refer to different parts and may therefore contain different numbers of pixels.

By utilising the splodes, the processor 220 is able to compare features which are relevant to the determination of banknote denomination whilst ignoring the majority of the banknote which would not aid denomination determination.

In order that the correlation technique function correctly, the processor 220 is adapted to receive the deskewed and sub-sampled image and then extract features for each splode. These splodes obtained from the banknote under test (or “sample patterns” as they will hereinafter be referred to) must then be compared with master patterns, which are patterns representing the splodes of each denomination of note. From this it will be appreciated that for each denomination splodes having the same configuration must be used.

Thus, in this example in which three splodes C,D,E are provided, each denomination of note must have three master patterns, with each master pattern corresponding to a respective one of the splodes.

### Master Pattern Determination

The master patterns are determined by experimentally scanning a predetermined number of sample banknotes and then applying a training sequence to ensure that the master patterns will not exclude any genuine from denomination determination.

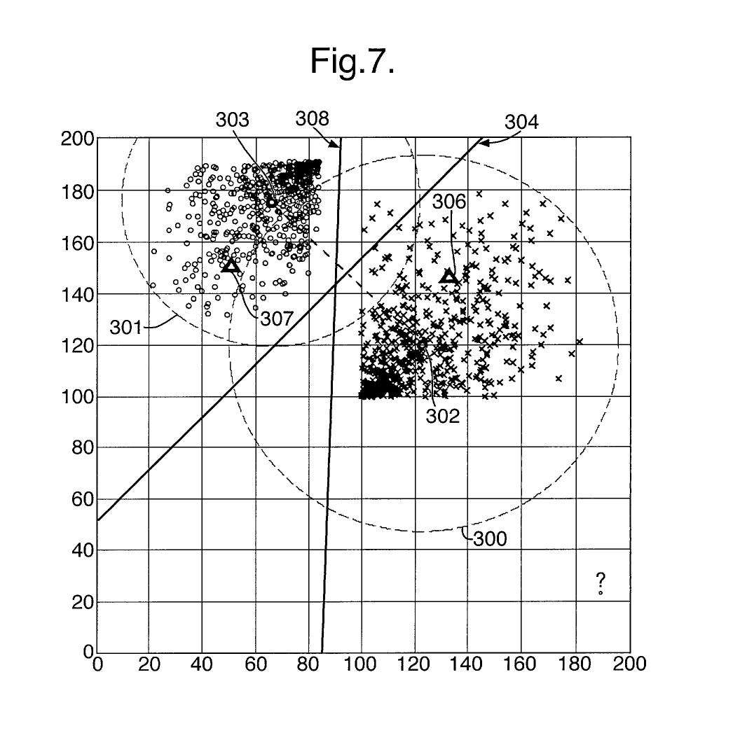

This process will now be described with reference to FIG. 7 which shows a simple example in which two classes are defined, each class representing a different denomination.

As each banknote of a given denomination is scanned, a respective banknote pattern representing the image of the entire banknote is determined.

Once this has been completed, the intensity values of each pixel in the banknote patterns are plotted in an N-dimensional space, where N is the number of pixels in each banknote pattern. This is repeated for all banknote patterns of all denominations to generate a number of classes.

An example of this is shown in FIG. 7 in which a number of banknote patterns from two different denominations have been plotted in a 2-D space (i.e. each banknote pattern contains only two pixels).

As shown in FIG. 7, the two denominations form two distinct classes 300,301. An average banknote pattern 302,303 is then calculated for each class 300,301, as shown.

A decision boundary 304 is then determined using the perpendicular bisector of a line 305 which joins the two averages 302,303.

It can be seen that four banknote patterns of the class 301 would be miss classified using the decision boundary 304. Accordingly, these four banknote patterns are used to modify the two averages 301,302 by adding weighted values to the average 302 and subtracting weighted values from the average 301.

A safety margin is then applied to the modified averages and this process repeated until all examples are correctly classified using the modified decision boundary 3080.

At this point the modified averages 306,307 represent whole banknote master patterns, for the entire banknote images, which have the highest possible safety margin, thereby providing the best solution.

Once the whole banknote master patterns have been generated, these are compared to determine which of the pixel locations in the original banknote images contribute to allowing the denomination to be determined. From this it is possible to determine the banknote features which contribute to the denomination determination process.

Having identified the banknote features, the splodes are then defined. The splodes are defined to ensure that each splode contains a similar number of banknote features, although this need not be identical.

Splode information concerning the features which define each splode are then stored in the memory 230. This can be achieved either by defining a mask which when placed over the deskewed, sub-sampled banknote image will leave only the features visible, or by simply defining the location of feature.

Thus, in the example of the one and five flavia banknotes shown in FIGS. 6A and 6B, each splode C,D,E contains four banknote features (each feature corresponding to one sub-pixel in the sub-sampled image). However, as an alternative any one of the splodes C,D,E may contain three or five features.

Master patterns are then generated for each splode for each denomination. This is achieved by simply extracting the relevant features from the master patterns of the entire banknote image. The master patterns are then normalised to aid the correlation process, as will be explained below, and stored in the memory 230.

### Correlation

The processor 220 performs a correlation procedure to correlate sample patterns obtained from the banknote under test with the master patterns stored in the 230.

In order to achieve this, the processor 220 receives the deskewed sub-sampled image and extracts the features from the image to obtain the sample patterns. This is achieved in accordance with the splode information stored in the memory 230, and will be achieved in a manner suitable to the type of information which has been stored.

In the examples of FIGS. 6A and 6B, the processor would therefore extract twelve features to generate three sample patterns, one for each splode C,D,E.

These sample patterns contain (sub-)pixel intensity values for each of the features in the relevant bill portions. Thus, the processor 220 will determine image intensity values at the points C1,C2,C3,C4, D1,D2,D3,D4 and E1,E2,E3,E4 to form the sample patterns.

Each sample pattern is then correlated with the master patterns for the same splode for each denomination. Thus the sample pattern of splode C would for example be correlated with the master patterns for splode C for the denominations $1,$5,$10,$20 . . . etc.

In order to achieve this, the correlation is carried out by performing a scalar product between the sample pattern and each master pattern. In this case, because the master patterns have been normalised, the result of the scalar product represents the degree of correlation between the sample pattern and the master pattern.

Accordingly, the correlation is performed for each denomination on a splode by splode basis.

This allows the processor 220 to determine the most likely denomination of each sample pattern. Once this has been completed, the results for each sample pattern are compared. If the majority of the sample patterns have the same denomination, then the banknote is classified as having that denomination, otherwise the banknote remains unclassified.

It will be apparent to a person skilled in the art that the use of splodes is particularly advantageous as it allows banknotes to be classified even if portions of the note are damaged so that some of the obtained sample patterns are miss- or un-classified.

Once this has been completed, a further check based on the dimensions or other note properties (such as magnetic or UV properties) can be performed to check the authenticity of the note (see step 190 above).

### Hierarchical Classification

As a development to the present invention, it is also possible to implement hierarchical classification. In this example, the classes defined by the master patterns are grouped together into domains, with master patterns being defined for each of the domains.

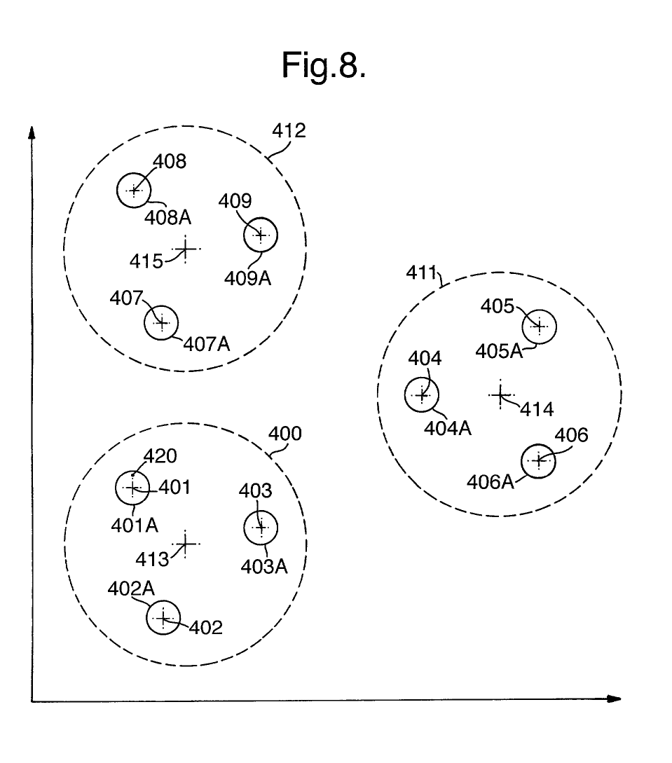

An example of this will now be described with reference to FIG. 8 which shows an example in which nine denominations of banknote are to be classified. In order to achieve this, nine classes need to be defined for each splode, with each class corresponding to a different denomination of banknote and each class having a respective master pattern.

Accordingly, if four splodes are used to identify the denomination of the banknotes, with nine possible denominations available, then altogether there will be thirty six classes. However, even in this case, the sample pattern corresponding to each splode will only be correlated with the nine classes of the corresponding splode for each denomination.

As set out above, nine classes are defined, with a master pattern being generated for each of the nine classes. The nine master patterns are plotted in a 2-D space in FIG. 8 and are shown as the points 401, . . . 409, with the corresponding classes shown as 401A, . . . 409A.

It is clear from the example shown in FIG. 8 that the master patterns 401, . . . 409 can be divided into three groups which contain master patterns having similar characteristics. Thus, in the example shown the master patterns 401,402,403 have similar characteristics and are therefore located in a similar region of the 2-D space.

Accordingly, this is used to define a domain shown by the dotted line 410. Similar domains 411,412 are also defined for the groups of the master patterns 404,405,406 and 407,408,409 respectively.

Once the domains has been defined, a domain master pattern is then calculated. The domain master pattern is calculated to allow the correlation procedure to determine whether a sample banknote falls within the relevant domain. Accordingly, in this example, three domain master patterns shown at points 413,414 and 415 are determined.

In use, when the processor 220 operates to carry out a denomination determination, this will be completed in a number of stages.

The first stage is to correlate the sample pattern with the domain master patterns 413,414,415 to determine to which domain 410,411,412 the sample pattern belongs. This is carried out in a manner similar to the correlation technique described above.

In this example the sample pattern is shown at 420. Accordingly, the correlation with the domain master patterns will result in the processor 220 determining that the sample pattern falls within the domain 410.

The second stage is to correlate the sample pattern with each of the master patterns 401,402,403 contained within the domain 410. Accordingly, in the second stage of correlation, the sample pattern is correlated with each of the master patterns 401,402,403 resulting in the determination that the sample pattern falls within the class 401A.

In this example, it will be appreciated that in order to determine the denomination of each splode, six correlations are required (one with each of the master patterns 413,414,415 and then one with each of the master patterns 401,402,403).

In contrast to this if the sample pattern was simply correlated with each of the master patterns 401, . . . 409 in turn, this would require nine correlation steps to be performed. This represents a reduction in the number of correlations required to determine the sample banknote denomination.

It will be appreciated that if this technique is used for identifying the denomination of each splode this can vastly reduce the number of correlation steps which are required.

This hierarchical correlation is typically performed using two layers of domain structure as set out in the above example. More layers may be used however if a large number of master patterns are used.

In the case in which two layers are used, it is preferable that the number of domains 410,411,412 in the first layer is the square root of the number of classes 401A, . . . 409A in the second layer. Furthermore it is preferable for each domain 410,411,412 to contain at least a number of classes equal to the square root of a total number of classes plus 1. In such a case, the maximum number of correlation sums which is required is twice the square root plus one.

Thus in this example with nine classes, there should be three domains 410,411,412 defined with each domain containing not more than four classes. In this case the maximum number of correlation sums that will be required is seven which is lower than the nine classes originally defined.

As a final development to the present invention, as each domain 410,411,412 has its own master patterns 413,414,415, these master patterns may correspond to domain splodes which are different to the splodes used in the correlation with the master patterns 401, . . . 409. This is because the correlation with each domain is an entirely separate classification problem to the correlation with each class.

In this case, domain splode information is stored in the memory 230 which defines the configuration of the domain splodes in terms of the banknote features which make up each domain splode. This is then used to determine domain sample patterns which are used in the correlation with the domain master patterns.

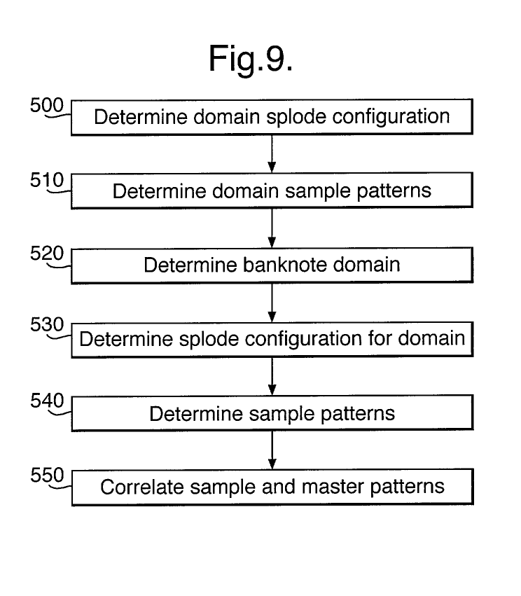

As a result, the correlation technique (step 170) becomes as shown in the flow diagram set out in FIG. 9.

Firstly, the processor 220 determines the configuration of the domain splodes at step 500 from domain splode information which is stored in the memory 230.

The processor 220 then determines domain sample patterns at step 510 from the deskewed, sub sampled image of the banknote using the domain splode information.

The processor 220 then determines the domain into which the banknote falls by correlating the domain sample patterns with the domain master patterns at step 520.

The processor would then determine the splodes used for correlation within this domain by accessing splode information stored in the memory 230. This may be different to the domain splodes determined in step 500 above. Furthermore it should be noted that the splodes used may vary between domains, so that in the present example, the splodes used may be different if it is determined that the banknote falls within domain 410 to if it falls within the other domains 411,412.

Having determined the splodes to be used in step 530, the processor 220 generates sample patterns in accordance with the splodes at step 540. The processor then correlates each sample pattern with the master patterns having the same splode configuration for each of the denominations within the respective domain, at step 550.

Having completed this the processor 220 examines the denomination to which each splode has been defined. If the majority of these are the same denomination then this is taken to be the banknote denomination.

I Claim:

1. A method of identifying the denomination of a sample currency bill, the method comprising:
a. Scanning the sample currency bill to generate a number of sample patterns, each sample pattern representing variations in properties of a respective bill portion of the scanned sample currency bill;
b. Correlating each sample pattern with a number of master patterns, each master pattern representing variations in the properties of a respective bill portion of a respective denomination currency bill, each bill portion containing at least a predetermined number of bill features, the bill features allowing different denominations of currency bill to be distinguished; and,
c. Determining the denomination of the sample currency bill in accordance with the result of the correlation.

2. A method according to claim 1, wherein denomination domains are defined, each domain containing a number of different denominations, and wherein the method further comprises selecting the number of master patterns by correlating domain sample patterns with domain master patterns, each domain master pattern representing the variations in the properties of a respective bill portion of the respective number of different denominations, each domain sample pattern representing variations in properties of a respective domain bill portion of the scanned sample currency bill, each domain bill portion containing at least a predetermined number of bill features allowing the domain of the sample currency bill to be distinguished.

3. A method of identifying the denomination of a sample currency bill, the method comprising:
a. Selecting a number of bill features which allow different denominations of currency bill to be distinguished;
b. Defining a number of bill portions, each bill portion containing at least a predetermined number of bill features;
c. Determining a master pattern for each bill portion of each denomination, each master pattern being determined by scanning the respective bill portion of a currency bill having the respective denomination;
d. Correlating the sample currency bill with at least a number of the master patterns by:
i. Scanning each bill portion of the sample currency bill to generate sample patterns for each bill portion of the sample currency bill;
ii. Correlating each sample pattern with the number of master patterns of the respective bill portions; and,
iii. Determining the denomination of the sample currency bill in accordance with the result of the correlation.

4. A method according to claim 3, wherein the method further comprises:
(1) Defining a number of different domains, each domain containing a number of different denominations;
(2) Determining a domain master pattern for each domain, each domain master pattern representing the variations in the properties of a respective bill portion of the respective number of different denominations; and,
(3) Correlating domain sample patterns with the domain master patterns, each domain sample pattern representing variations in properties of a respective domain bill portion of the scanned sample currency bill, each domain bill portion containing at least a predetermined number of bill features allowing the domain of the sample currency bill to be distinguished; and,
(4) Selecting the number of master patterns with which the sample pattern is correlated in accordance with the result of correlation performed in step (3).

5. A method according to claim 2, wherein the domain sample patterns are the sample patterns and the domain bill portions are the bill portions.

6. A method according to claim 1, wherein the method of scanning the sample currency bill to generate sample patterns comprises:
a. Progressively exposing adjacent segments of the sample currency bill to radiation;
b. Detecting the radiation transmitted by or reflected from each segment of the sample currency bill, to thereby determine a bill pattern for the entire sample currency bill; and,
c. Dividing the bill pattern into a number of sample patterns in accordance with the bill portions.

7. A method according to claim 6, wherein the properties of the bills are transmission or reflectance characteristics of the bill when exposed to the radiation.

8. A method according to claim 1, wherein the method of correlating the sample patterns with the master patterns comprises:
a. Representing the master patterns as vectors, each dimension of each vector representing the variations in the bill properties at a given point of the bill portion;
b. Representing the sample patterns as vectors, each dimension of each vector representing the variations in the properties of the sample currency bill at the given point of the bill portion;
c. Determining the scalar product of each sample pattern with the master patterns of the respective bill portions for each denomination; and,
d. Determining the denomination of the sample pattern to be the denomination of the master pattern for which the highest scalar product is determined.

9. A method according to claim 8, wherein the master patterns are represented as normalised vectors.

10. A method according to claim 1, wherein the denomination of the sample bill is determined if the majority of the sample patterns correlate with the master patterns of a given denomination.

11. A method according to claim 1, wherein the bill features are bill locations which have respective different properties for respective different denominations.

12. A method according to claim 1, wherein each bill portion is defined in terms of a number of bill features.

13. Apparatus for identifying the denomination of a sample currency bill, the apparatus comprising:
a. A scanning system for scanning the sample currency bill to generate a number of sample patterns, each sample pattern representing variations in properties of a respective bill portion of the scanned sample currency bill;
b. A store for storing master patterns, each master pattern representing variations in the properties of a respective bill portion of a respective denomination currency bill, each bill portion containing at least a predetermined number of bill features, the bill features allowing different denominations of currency bill to be distinguished; and,
c. A processor coupled to the scanning system and the store, wherein the processor is adapted to determine the denomination of a sample by
i. Correlating each sample pattern with at least a number of the master patterns of the respective bill portions for the different denominations of currency bill; and,
ii. Determining the denomination of the sample currency bill in accordance with the result of the correlation.

14. Apparatus according to claim 13, wherein denomination domains are defined, each domain containing a number of different denominations, the store storing domain master patterns, each domain master pattern representing the variations in the properties of a respective bill portion of the respective number of different denominations, the processor being further adapted to select the number of master patterns by correlating domain sample patterns with the domain master patterns, each domain sample pattern representing variations in properties of a respective domain bill portion of the scanned sample currency bill and each domain bill portion containing at least a predetermined number of bill features allowing the domain of the sample currency bill to be distinguished.

15. Apparatus according to claim 14, wherein details of the domain bill portions are stored in the store.

16. Apparatus according to claim 14, wherein the scanning system comprises:
a. A radiation source for selectively exposing the sample currency bill to radiation;
b. A bill transport system for transporting the bill past the radiation source, the bill transport and the radiation source cooperating so as to progressively expose adjacent segments of the sample currency bill to radiation; and,
c. A detector for detecting the radiation transmitted by or reflected from each segment of the sample currency bill to thereby determine a bill pattern for the entire sample currency bill.

17. Apparatus according to claim 16, wherein the processor is further adapted to divide the bill pattern into a number of sample patterns in accordance with the bill portions.

18. Apparatus according to claim 13, wherein the properties of the bills are transmission or reflectance characteristics of the bill when exposed to the radiation.

19. Apparatus according to claim 13, wherein the processor is adapted to correlate the sample patterns with the master patterns by:
a. Representing the master patterns as vectors, each dimension of each vector representing the variations in the bill properties at a given point of the bill portion;
b. Representing the sample patterns as vectors, each dimension of each vector representing the variations in the properties of the sample currency bill at the given point of the bill portion;
c. Determining the scalar product of each sample pattern with the master patterns of the respective bill portions for each denomination; and,
d. Determining the denomination of the sample pattern to be the denomination of the master pattern for which the highest scalar product is determined.

20. Apparatus according to claim 13, wherein the processor is adapted to determine the denomination of the sample bill if the majority of the sample patterns correlate with the master patterns of a given denomination.

21. Apparatus according to claim 13, wherein the bill features are bill locations which have respective different properties for respective different denominations, details of the bill locations of the bill features being stored in the store.

22. Apparatus according to claim 21, wherein each bill portion is defined in terms of a number of bill features, the store storing an indication of the bill features comprising each bill portion.

23. A method of generating master patterns for identifying the denomination of a sample currency bill, the method comprising:
a. Scanning one or more currency bills of each denomination so as to determine component patterns representing variations in properties of the scanned currency bills;
b. Comparing the component patterns of different denomination scanned currency bills to determine a number of bill features which allow the different denominations to be distinguished;
c. Defining a number of bill portions, each bill portion containing at least a predetermined number of bill features; and,
d. Generating a master pattern for each bill portion of each denomination, each master pattern being determined by scanning the respective bill portion of a currency bill having the respective denomination.

24. A method of identifying the denomination of a sample currency bill according to claim 1, wherein the master patterns are generated in accordance with claim 23.
